(19) United States
(12) Patent Application Publication
(10) Pub. No.: US 2005/0043989 A1
(43) Pub. Date: Feb. 24, 2005

(54) System and method of facilitating content delivery to a user

(76) Inventor: Daniel G. Shifrin, New York, NY (US)

Correspondence Address: COLLIER SHANNON SCOTT, PLLC, 3050 K STREET, NW, SUITE 400, WASHINGTON, DC, 20007, US

(21) Appl. No.: 10/642,659

(22) Filed: Aug. 19, 2003

(51) Int. Cl. G06F 17/60; H04K 1/00; H04L 9/00

(52) U.S. Cl. 705/14; 705/80

(57) ABSTRACT

A method is disclosed for facilitating the delivery of content from a content provider to a user. The method comprises the steps of receiving authorization from the user to represent the user to the content provider; and negotiating an agreement between the content provider and the user to provide content to the user and to provide compensation to the user for receiving the content. The content may comprise at least one advertisement.

### FIELD OF THE INVENTION

The present invention relates generally to consumer marketing and privacy. In particular, the present invention relates to a system and method of facilitating the delivery of content between a content provider and a user.

### BACKGROUND OF THE INVENTION

Targeted direct marketing has long been an effective method for reaching the consumer and generating increased revenue for the marketer. By delivering to the consumer specifically targeted advertisements and related content, the consumer is more likely to respond and purchase the product or service being advertised. To further increase the effectiveness of the advertising, the marketer will often deliver the content directly to any of the user's “personal advertising property,” including, for example, the user's: telephone, email account, wireless device, PDA, personal computer, vehicle, television, and multi-media experience.

Although marketers earn billions of dollars in revenue per year from accessing the user's property, the user typically receives no compensation in return. This failure to compensate the user occurs even when the user owns the property being accessed by the marketer. For example, a consumer who purchases an email account may be bombarded by unwanted spam email, but receive nothing but a clogged email box. In contrast, the email marketer and their clients may earn substantial revenue from trespassing on the consumer's email address. The results are the same when the direct marketer delivers content to the consumer's telephone, personal computer, and other personal advertising property—although the consumer bears the burden of receiving the content, they are not rewarded for their time and attention. Many consumers believe they have a right to be compensated for the use of their property.

In some instances, a consumer may choose to receive content from a marketer. Consumers may choose to receive additional information and content about a product, for example, when they make an on-line purchase. In some cases, a consumer may even receive nominal compensation for “opting-in” to receiving content from a particular content provider. The consumer does not, however, have the option of negotiating the amount and type of content and/or compensation received. A marketer may be unwilling to deal with the demands of a single consumer. Accordingly, it is desirable to have an agent acting on behalf of a consumer population to promote and create value from each consumer's personal advertising property.

Even those consumers who opt-in with content providers and receive useful, solicited content may also receive countless instances of unsolicited marketing content. Many consumers consider these unsolicited telemarketing calls and spam email messages an invasion of their privacy. Despite regulations relating to telemarketing and “spam detectors” offered by email account hosts, the volume of unsolicited content reaching the user remains significant. Many consumers are interested in preventing this unsolicited marketing from reaching their property.

The National Do Not Call List Act was drafted to allow consumers to add their name to the National Do Not Call List. Because it prohibits most advertisers from soliciting participating consumers via the telephone or a wireless device against the consumer's wishes, this list may have a significant impact on the direct marketing industry. Coupled with growing consumer angst against direct marketing, this list, along with similar lists relating to other types of direct marketing, may create a significant consumer supply shortage and may generate instant demand from content providers and their clients for opt-in consumer populations.

The system and method of the present invention answers the needs of both the consumer and the marketer, and at least some embodiments of the present invention provide significant advantages over the prior art. It is an advantage of embodiments of the present invention to provide a system and method for representing a consumer to a content provider for the purpose of promoting the user's personal advertising property and protecting the user's privacy. It is an additional advantage of embodiments of the present invention to respond to an increased demand from marketers and their clients for relevant and reliable consumer populations. It is a further advantage of embodiments of the present invention to provide an exchange where access to a consumer's time and attention may be traded for financial compensation and relevant advertising. Additional advantages of various embodiments of the invention are set forth, in part, in the description that follows and, in part, will be apparent to one of ordinary skill in the art from the description and/or from the practice of the invention.

### SUMMARY OF THE INVENTION

Responsive to the foregoing challenges, Applicant has developed an innovative system and method of facilitating delivery of content from a content provider to a user. The method comprises the step of negotiating an agreement between the content provider and the user to provide content to the user and to provide compensation to the user for receiving the content. The content may comprise, for example, at least one advertisement.

Applicant has further developed an innovative method of promoting a user for receiving content from a content provider. In one embodiment, the method comprises the steps of: receiving authorization from the user to represent the user to the content provider; receiving an offer from the content provider to provide content to the user; communicating acceptance of the offer to the content provider on behalf of the user; and providing the content to the user.

Applicant has developed an innovative computer readable medium containing program instructions for: receiving authorization from a user to represent the user to a content provider; receiving an offer from the content provider to provide content to the user; and communicating acceptance of the offer to the content provider on behalf of the user.

Applicant has further developed an innovative system for representing a user to a content provider, comprising an agent for negotiating an agreement between a content provider and a user to provide content to the user and to provide compensation to the user for receiving the content.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements.

FIG. 1 is a schematic diagram of the system for facilitating the delivery of content from a content provider to a user according to an embodiment of the present invention.

FIG. 2 is a flow chart of a method for facilitating the delivery of content from a content provider to a user according to an embodiment of the present invention.

FIG. 3 is a flow chart illustrating the user authorization process according to an embodiment of the present invention.

FIG. 4 is a flow chart illustrating the agreement negotiation process according to an embodiment of the present invention.

FIG. 5 is a flow chart illustrating the content delivery process according to an embodiment of the present invention.

FIG. 6 is a flow chart illustrating the compensation process according to an embodiment of the present invention.

### DETAILED DESCRIPTION OF EMBODIMENTS OF THE INVENTION

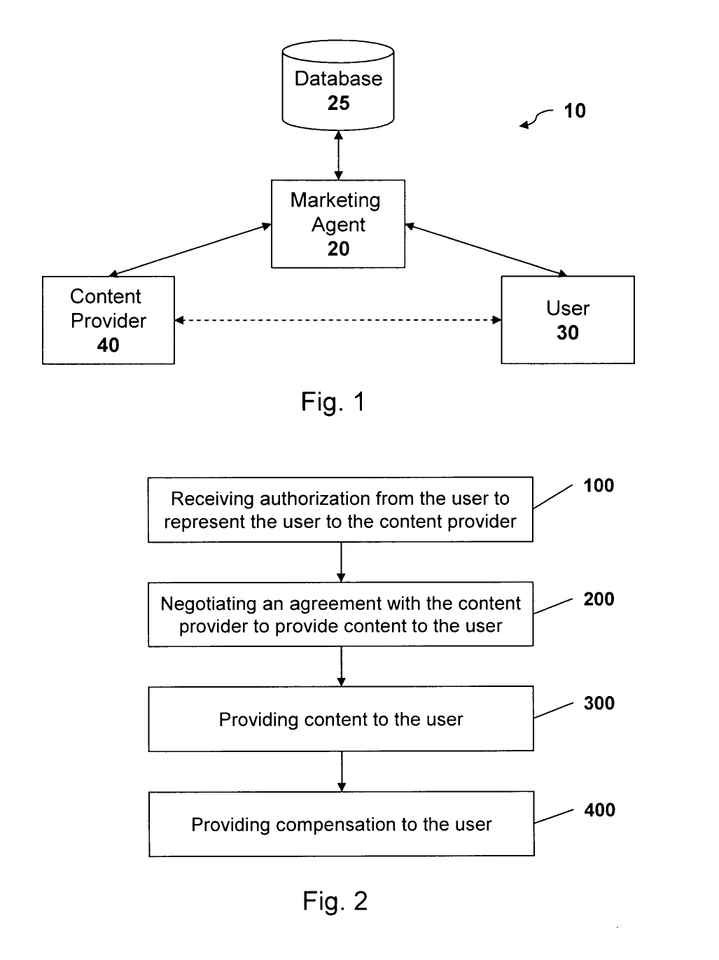

Reference will now be made in detail to embodiments of the system and method of the present invention, examples of which are illustrated in the accompanying drawings. With reference to FIG. 1, an embodiment of the present invention is shown as a system 10 for facilitating the delivery of content from a content provider to a user.

The system 10 includes a marketing rights agent 20 in communication with at least one content provider 40 and at least one user 30. The agent 20 preferably comprises a web-based application, and may be in communication with the content provider 40 and the user 30 over a network, such as, for example, the Internet. The agent 20 is in communication with at least one database 25 for storing information relating to the content provider 40 and the user 30. The content provider 40 and the user 30 may have access to the information residing on the database 25. In one embodiment of the present invention, the content provider 40 may have restricted access to the information residing on the database 25.

The agent 20 facilitates the delivery of content from the content provider 40 to the user 30. As shown in FIG. 2, the agent 20 receives authorization from the user 30 to represent the user 30 to the content provider 40. The agent 20 negotiates an agreement with the content provider 40 to provide the content to the user 30. The content is provided to the user 30, preferably by the content provider 40. The user 20 then receives compensation for receiving the content.

The content provider 40 may comprise any entity involved in providing content to the user 30, including, but not limited to, an advertiser, a direct marketer, an email marketer, a telemarketer, product manufacturer, service provider, and/or an Internet Service Provider (ISP). It is contemplated that the content provider 40 may comprise a party acting on behalf of one or more content providers.

The content provided to the user 30 may include any marketing related content. The content may include, but is not limited to, an advertisement, an inbound telephone message, an outbound telephone message, an email message, an on-line advertisement, a website link, a game, a logo, a commercial, a lottery, a promotion, an instant-win component, a graphic to be affixed to the user's vehicle, a celebrity guest voice, a poll, special effects, music, video, audio, or any other content provided to the user 30.

The present invention as described herein is intended to operate on one or more server computers. As will be apparent to those of ordinary skill in the art, this can be accomplished, for example, by users and content providers accessing computer readable media stored on the one or more servers via the Internet. This readable media contains program instructions for accomplishing various process steps described below. The one or more servers may be adapted to operate on any platform required, including, but not limited to a, Unix, Linux, and/or Microsoft platform.

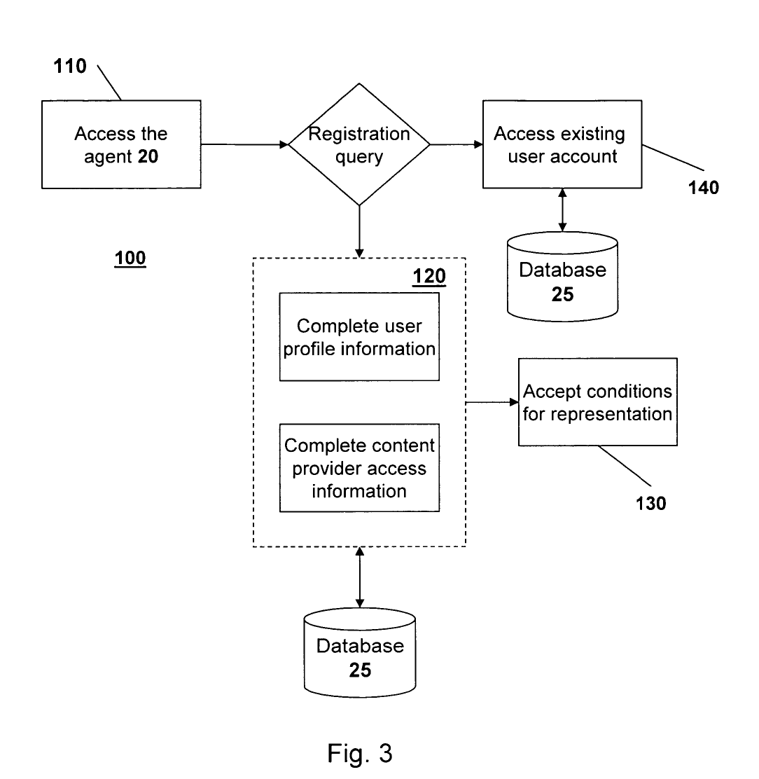

FIG. 3 is a flow chart illustrating the user authorization process 100 according to one embodiment of the present invention. The user 30 engages the agent 20 and grants authorization to represent them for receiving content from the content provider 40. In step 110, the user accesses the agent 20, for example, via an Internet website. The user 30 may be directed to access the agent 20 by marketing material provided to the user 30.

After the user has accessed the agent 20, the user receives a registration query. If the user indicates that he is not registered, the user may be provided with first-time user or non-registered user introductory information. In step 120, the user is then directed to a registration interface to establish a user account. The user 30 enters data through the registration interface to create a user profile. The data may include, for example, detailed demographic and geographic information relating to the user 30. The information provided in the user profile may narrow the content received from the content provider 40, such that the user 30 receives only content (e.g., advertisements relating to products and services) in which the user is interested.

The user 30 may also provide content provider access information in order to define the content providers 40 that have access to the individual's user profile. The user may specify the types of content providers from whom they wish to receive content. The user may also indicate specific content providers 40 with which they wish to communicate and/or specific content providers 40 with which they do not wish to communicate. The content provider access information may be included in the user's profile. The completed user profiles are stored in the database 25, and are accessible to approved content providers 40.

In step 130, after completing the user profile, the user accepts conditions for the agent's representation to the content provider 40. The user 30 is presented with the agent's privacy policy and the terms and conditions for the representation. In some, but not necessarily all, embodiments of the present invention, the user may be required to accept terms and conditions for representation relating to one or more of the following: user age requirements, user citizenship requirements, compensation type, compensation amount, term of representation, and exclusivity of representation. In one embodiment of the present invention, the user may be required to agree to update their user profile at predetermined time periods. In one embodiment of the present invention, the user may be required to interact with at least one instance of content during a predetermined time period. For example, the user may be required to listen to one phone advertisement per month, if an agreement with a content provider is established. In one embodiment of the present invention, the user may be required to agree to participate in class action litigation against a content provider.

After the user 30 has accepted the terms and conditions of the agreement, the authorization process is complete. In one embodiment of the present invention, new users may receive a “welcome” communication from the agent 20, containing instructions and other relevant information relating to the system 10.

Registered or existing users may access the agent 20, for example, by providing a username and/or password. As shown in step 140, an existing user may access their existing user account to update profile information and interests, view earnings, redeem earnings, and/or engage in on-line shopping. It is contemplated that existing users may accomplish various other functions when accessing the agent 20.

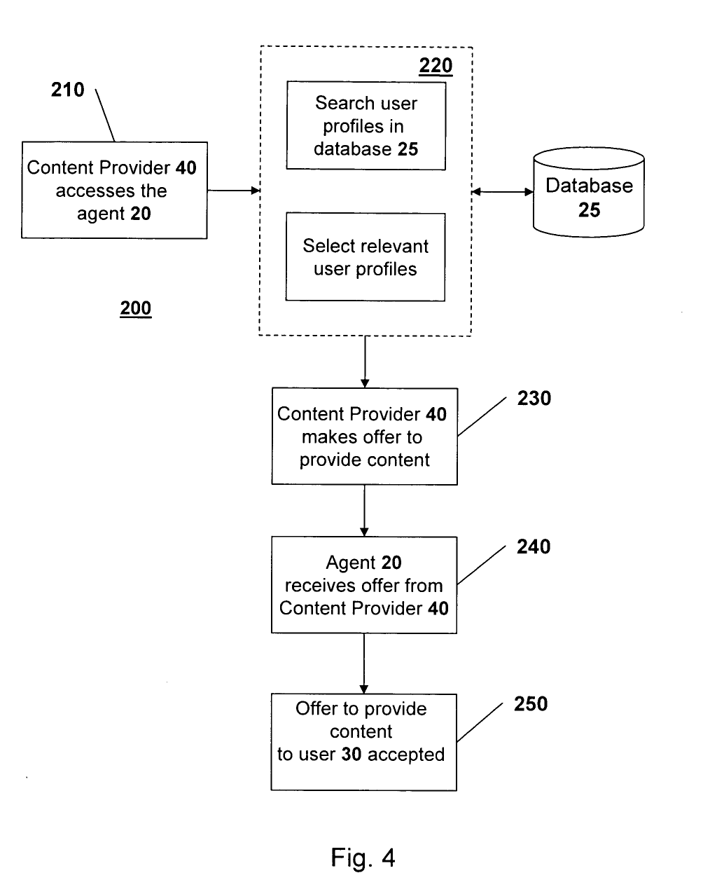

FIG. 4 is a flow chart illustrating the agreement negotiation process according to one embodiment of the present invention. The agent 20 negotiates an agreement between the content provider 40 and the user 20. In step 210, the participating content provider 40 accesses the agent 20. As shown in step 220, the content provider 40 may then search through the user profiles stored on the database 25 via an online interface. The content provider's access may be limited to only those user profiles in which the user 30 has granted access permission to that content provider 40. The content provider 40 then selects relevant users 30 to whom they are interested in delivering content. For example, the content provider 40 may select users having a particular demographic or geographic characteristic, or interest.

In step 230, the content provider 40 makes an offer to provide content to the user 30. This may be accomplished through an on-line interface hosted by the agent 20 that prompts the content provider 40 to provide offer data detailing their interest. The offer data may include, but is not limited to, information relating to the content to be provided (e.g., products or services to be advertised), the number of instances of content expected to be delivered, coupon and/or discount opportunities, revenue per lead data, and/or the amount and type of compensation to be provided to the user. In the case in which the content provider 40 is an agent of one or more advertisers, the content provider 40 may further provide details about the client(s) they represent. The details of the offer are saved into the database 25.

In step 240, the agent 20 receives the offer from the content provider 40. Based on the contents of the offer, the agent 20 generates an Agreement which includes the terms and conditions of the relationship between the user 20 and the content provider 40. If the terms of the Agreement are acceptable, the content provider 40 commits to the Agreement. The agent 20 may then send the content provider 40 a confirmation communication (e.g., email, and/or voicemail) confirming the offer and explaining the user acceptance process.

In step 250, if determined to be acceptable, the offer to provide content to the user 20 is accepted. In one embodiment of the present invention, the agent 20 accepts the content provider's offer on behalf of the user 20, and communicates the acceptance to the content provider 40 and the user 30. This acceptance may be based on information provided by the user 30 in the user profile. The acceptance may be communicated to the content provider 40 and the user 30 via, for example, an email notification, and/or a voicemail notification. The content provider 40 may then provide content to the user 30 pursuant to the terms and conditions of the Agreement.

In an alternative embodiment, the user 30 may accept the offer from the content provider 40 directly. In this embodiment, upon acceptance of the Agreement by the content provider 40, the offer will be forwarded to the user 30 for their consideration. In one embodiment, the offer is forwarded to the user 30 via an email including an embedded link to an on-line offer acceptance interface hosted by the agent 20. After accessing the offer acceptance interface, the user 30 is required to read the terms and conditions of the Agreement detailing the offer. If the terms and conditions of the Agreement are acceptable, the user 30 accepts the Agreement. The accepted Agreement is stored in the database 25 and a notice is communicated to the user 30 and the content provider 40. The content provider 40 may then provide relevant content to the user 30 pursuant to the terms and conditions of the Agreement.

If the offer submitted by the content provider 40 is unacceptable to the user 30, a counter-offer may be communicated to the content provider 40. When the user 30 accesses the offer acceptance interface, the user 30 enters counter-offer data. Based on the contents of the offer, the agent 20 generates a revised Agreement which includes the revised terms and conditions of the relationship between the user 20 and the content provider 40. If the terms of the revised Agreement are acceptable, the user 30 commits to the revised Agreement, and submits the counter offer. The revised Agreement is stored in the database 25. The agent 20 may then send the content provider 40 a communication (e.g., an email, and/or voicemail) indicating that a counter-offer has been made. After accessing the offer acceptance interface, the content provider 40 indicates their acceptance or rejection of the revised Agreement. If the terms and conditions of the revised Agreement are acceptable, the content provider 40 accepts the revised Agreement. The accepted Agreement is stored in the database 25 and a notice is communicated to the user 30 and the content provider 40. The content provider 40 may then provide relevant content to the user pursuant to the terms and conditions of the Agreement. If the content provider 40 rejects the user's counter offer, the user will receive a communication and no agreement is established.

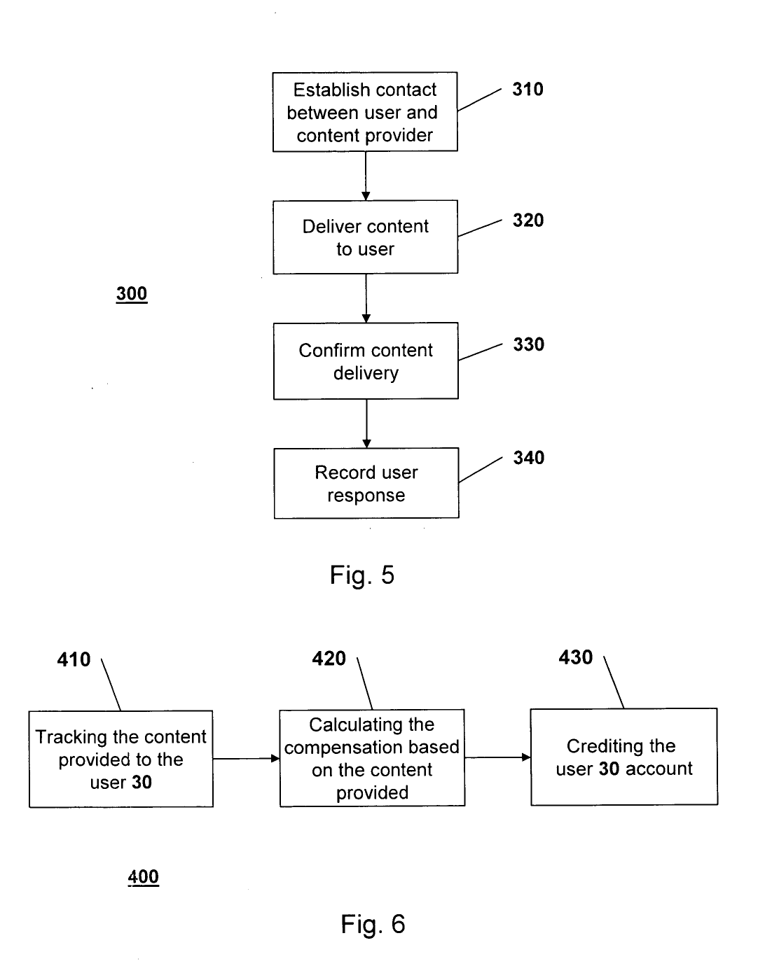

FIG. 5 is a flow chart illustrating the content delivery process 300 according to an embodiment of the present invention. The content delivery process will be described in connection with an inbound telephone advertising embodiment. As described above, however, the content provided to the user 30 may include any marketing related content.

As shown in step 310, the content provider 40 and the user 30 establish contact. In the case of inbound telephone marketing, for example, the user 30 may contact the content provider 40 by dialing a toll-free telephone number. In step 320, the content is then delivered to the user 30. For example, in the case of inbound telephone marketing, a message or series of messages is played to the user over the phone. The messages may include an advertisement that is relevant to the user based on the user profile stored in the database 25.

As shown in step 330, the delivery of the content is then confirmed. After listening to a message(s), the user is prompted to verbally, or through the use of the telephone keypad, respond to a question or series of questions relating to the message. This may be accomplished using known Interactive Voice Response (IVR), Advanced Voice Recognition (AVR), and/or related telephony technologies. Alternatively, the user 30 may be prompted to speak directly with the content provider 40. The questions may be adapted to determine whether the user 30 has listened to the particular message. A correct answer to a question, for example, may demonstrate that the user has listened to and understood the message. The user 30 may also request to re-listen to the message(s).

As shown in step 340, the results of the user's responses are recorded in the database 25. This may be accomplished using known Voice Extensible Markup Language (VXML) technology, such as, for example, VoiceXML or VMXL. The content provider 40 may then access the results via the database 25 and analyze the effectiveness of the advertisement.

In one embodiment of the present invention, before, during, or after delivery of the content, the user 30 may request additional information regarding the content (e.g., the advertised product or service) or make a purchase. If additional information is requested, the user may be directed to a call center where direct contact between the content provider 40 and the user 30 is established.

FIG. 6 is a flow chart illustrating the compensation process 400 according to one embodiment of the present invention. In step 410, data relating to the content provided to the user 30 is tracked and recorded in the user's account in the database 25. This data may include, for example, the number of instances the content was provided to the user 30. As will be apparent to those of ordinary skill in the art, the tracking may be accomplished by hardware and software designed for routing content including, but not limited to, IVR, AVR, and VXML related technology. The necessary hardware and software may be located at the content provider 40. In one embodiment, the content provider 40 may route the delivery of the content through the agent 20 such that the data relating to the content provided to the user 30 is tracked directly by the agent 20.

As shown in step 420, on a periodic basis the agent 20 accesses the user's account and reviews the tracking data. Based on the data, the agent 20 calculates the compensation due to the user 30 and generates an invoice. The invoice is communicated to the content provider 40. In step 430, the user's account is credited with the compensation. In one embodiment of the present invention, the content provider 40 may be required to deposit in the user account, or with the agent 20, the compensation due to the user before actual delivery of the content to the user.

Based on the data, the agent 20 may also calculate the compensation due to the agent 20 for services provided. This compensation may be provided to the agent 20 by the content provider 40, or by the user 30, depending on the terms of the Agreement.

If the content provider 40 violates the terms and conditions of the Agreement, the user 30 may opt-out of the content delivery. The user 30 may access an opt-out interface hosted by the agent 20 and indicate their desire to be removed from the content provider's content delivery list. The information provided by the user 30 is stored in the database 25, and an opt-out notice is communicated to the content provider.

The agent 20 may also act to protect the privacy of the user 30. When a user 30 receives unsolicited content from a content provider 40 the user 30 may contact the agent 20. The user 30 may access a content provider complaint interface hosted by the agent 20 and provide data relating to the offending content and/or content provider. For example, the user 30 may provide an email address (in the case of an offending spam email provider) or a telephone number (in the case of an offending telemarketer). The complaint is stored in the database 25. Upon receipt of the complaint from the user 30, the agent 20 generates a cease and desist notice describing the agent's representation of the user 30, and citing the violation of the user's privacy. The notice is communicated to the content provider 40 using any available contact information, and copied to the user 30. If the user 30 receives an additional unsolicited instance of content from the content provider 40, the complaint process is repeated. If a second cease and desist communication is ignored by the content provider 40, the agent 20 may attempt to identify the content provider 40 and submit all relevant information to the Federal Communications Commission (FCC), or other regulatory body. The agent 20 may also organize and file a lawsuit on behalf of the user 30 against the content provider 40.

It will be apparent to those skilled in the art that variations and modifications of the present invention can be made without departing from the scope or spirit of the invention.

1. A method of facilitating delivery of content from a content provider to a user, said method comprising the steps of: negotiating an agreement between the content provider and the user to provide content to the user and to provide compensation to the user for receiving the content, wherein the content comprises at least one advertisement.

2. The method of claim 1, wherein the content comprises at least one selected from the group consisting of: a telephone message including an advertisement, an email message including an advertisement, and an on-line advertisement.

3. A method of facilitating delivery of content from a content provider to a user, said method comprising the steps of:
receiving authorization from the user to represent the user to the content provider; and
negotiating an agreement between the content provider and the user to provide content to the user.

4. The method of claim 3, further comprising the step of the content provider providing the content to the user.

5. The method of claim 4, further comprising the step of providing compensation to the user for receiving the content.

6. The method of claim 3, wherein the step of receiving authorization further comprises the steps of:
establishing a user account containing a profile of the user; and
the user accepting conditions for the representation.

7. The method of claim 6, wherein the step of negotiating an agreement further comprises the steps of:
receiving an offer from the content provider to provide content to the user; and
accepting the offer on behalf of the user based on the user profile.

8. The method of claim 7, further comprising the step of selectively granting the content provider access to the user profile.

9. A method of promoting a user for receiving content from a content provider, said method comprising the steps of:
receiving authorization from the user to represent the user to the content provider;
receiving an offer from the content provider to provide content to the user;
communicating acceptance of the offer to the content provider on behalf of the user; and
providing the content to the user.

10. The method of claim 9, further comprising the step of providing compensation to the user for receiving the content.

11. The method of claim 9, wherein the content is provided to the user by the content provider.

12. The method of claim 10, wherein the compensation is provided to the user by the content provider.

13. The method of claim 10, further comprising the steps of:
establishing a user account containing a profile of the user; and
selectively permitting access to the user profile by the content provider.

14. The method of claim 13, wherein the step of establishing a user profile further comprises the steps of:
collecting data relating to the user; and
storing the data in a location accessible by the user and the content provider.

15. The method of claim 9, wherein the content comprises a telephone message including an advertisement.

16. The method of claim 9, wherein the content comprises an email message including an advertisement.

17. The method of claim 9, wherein the content comprises an on-line advertisement.

18. The method of claim 9, wherein the step of providing the content to the user further comprises the step of the user contacting the content provider.

19. The method of claim 13, further comprising the step of tracking the content provided to the user.

20. The method of claim 19, further comprising steps of:
calculating the compensation based on the content provided to the user; and
crediting the user account with the compensation.

21. A method of representing a user for receiving content, said method comprising the steps of:
establishing a user account containing a profile of the user;
selectively granting a first content provider access to the user profile;
receiving an offer from the first content provider to provide content to the user;
communicating acceptance of the offer to the first content provider on behalf of the user; and
providing the content to the user.

22. The method of claim 21, further comprising the step of communicating a counter-offer to the first content provider on behalf of the user.

23. The method of claim 21, further comprising the step of providing compensation to the user for receiving the content.

24. The method of claim 23, further comprising the step of tracking the content provided to the user.

25. The method of claim 24, further comprising the steps of:
calculating the compensation based on the content provided to the user; and
crediting the user account with the compensation.

26. The method of claim 21, further comprising the step of communicating to a second content provider a demand to cease providing content to the user.

27. A computer readable medium containing program instructions for:
receiving authorization from a user to represent the user to a content provider;
receiving an offer from the content provider to provide content to the user; and
communicating acceptance of the offer to the content provider on behalf of the user.

28. The computer readable medium of claim 27, further containing program instructions for:
establishing a user account containing a profile of the user; and
selectively permitting access to the user profile by the content provider.

29. The computer readable medium of claim 28, further containing program instructions for:
calculating compensation to be provided to the user for receiving the content based on the content provided to the user; and
crediting the user account with the compensation.
